(19) United States
(12) Patent Application Publication
(10) Pub. No.: US 2007/0252339 A1
(43) Pub. Date: Nov. 1, 2007

(54) Cylinder head gasket

(75) Inventors: Shinichiro Ishikawa, Tokyo (JP); Yuuichi Kinoshita, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: ISHIKAWA GASKET CO., LTD, Tokyo (JP)

(21) Appl. No.: 11/822,194

(22) Filed: Jul. 3, 2007

Related U.S. Application Data
(62) Division of application No. 11/330,199, filed on Jan. 12, 2006.

(30) Foreign Application Priority Data
Jan. 26, 2005 (JP) 2005-017963

(51) Int. Cl. B60T 11/236

(52) U.S. Cl. 277/494

(57) ABSTRACT

A cylinder head gasket is formed by a metal plate, for constituting the gasket, having at least one cylinder hole and a plurality of bolt holes arranged to surround the at least one cylinder hole. Bolt-hole beads are formed in the metal plate to surround the respective bolt holes. Also, suppress adjusting beads are formed in the metal plate to be situated between adjacent bolt-hole beads, and said suppress adjusting beads and said bolt-hole beads are spaced to have a gap therebetween.

### CROSS-REFERENCE TO RELATED APPLICATION

This is a divisional application of Ser. No. 11/330,199, filed on Jan. 12, 2006.

### BACKGROUND OF THE INVENTION AND RELATED ART STATEMENT

The present invention relates to a cylinder head gasket to be installed between two members, such as a cylinder head and a cylinder block of an engine, to seal therebetween. More specifically, the present invention relates to the cylinder head gasket being able to control the deformation of a cylinder bore.

The cylinder head gasket is fastened by head bolts in a state of being installed between the cylinder head and cylinder block (cylinder body) of an auto engine and has the role of sealing a fluid such as combustion gas, oil, and coolant water.

On the other hand, recently, with the improvement of fuel consumption and enhancement of antipollution measures, there is a tendency of miniaturization of the automobile engine. In a small engine, fuel efficiency is a focal point of engine development, wherein the improvement of the fuel consumption is enhanced by reducing the friction resistance between the piston ring and cylinder.

One reason of the friction resistance is the deformation of the cylinder bore. Generally, the size or form of the deformation of the bore varies by an engine structure; however, when the gasket is installed, the deformation of the bore is commonly amplified regardless of the engine structure.

Especially, a small size engine whose cylinder block is an open-deck type and made of aluminum is increased. Since the engine offers excellent productivity, there is a tendency that the mini-aluminum engine could become the main due to the production cost.

However, in an open-deck type engine whose joint surface of water jacket relative to the cylinder head is open, as shown in FIG. 13, when the gasket is fastened by fastening bolts, in the upper part of the cylinders, cylinder bores (NO. 1 and NO. 4) on both ends in a longitudinal direction become deformed in a triangle shape by being pulled and stretched in three directions wherein the cylinder bores (NO. 1 and NO. 4) face outwardly. Also, the cylinder bores (NO. 2 and NO. 3) placed in the middle area become deformed in an oval shape by being pulled and stretched in a width direction, i.e., in two directions which face outwardly.

In an open-deck type cylinder block, a water hole for the coolant water surrounding the cylinder bores has an opening on the upper part of the cylinders. Accordingly, when the gasket is installed and the fastening bolts are fastened, bolt holes are strongly pressed, so that cylinder walls, upper sides of which are not supported, has a tendency to fall in a direction of the bolt holes, i.e. to a water hole.

Measures to control the deformations of the cylinder bores are carried out according to each state in an engine structure or gasket structure, and one of the important challenges in the cylinder head gasket is how to control amplification of the volume of the deformation of the bore.

On the other hand, in the cylinder head gasket, as a means for increasing compression resistance without sacrificing a sealing function, a metal gasket improving sealing performance around the cylinder bores or the other sealing holes by waved beads or meandering beads, which look like a waveform from in a plan view (for example, refer to Patent Document 1), has been proposed. However, in the cylinder head gasket, the problem of the deformation of the cylinder bores is not referred to. [Patent Document 1] Japanese Patent Publication No. H11-280551

The present invention has been made in order to solve the above-mentioned problems, and the object of the invention is to provide a cylinder head gasket capable of controlling the deformation of the cylinder bores of the engine by placing the beads in appropriate parts.

Further objects and advantages of the invention will be apparent from the following description of the invention.

### SUMMARY OF INVENTION

In order to achieve the above-mentioned objects, a cylinder head gasket of the present invention which includes bolt-hole beads surrounding the bolt holes around the bolt holes is provided respectively in either one of the metal plates of the cylinder head gasket constituted by single or multiple number of metal plates. At the same time, suppress adjusting beads connecting the adjacent bolt-hole beads to each other are provided.

Also, in the cylinder head gasket, the suppress adjusting bead is formed in an arc shape in such a way that the suppress adjusting bead projects in the outer direction of the gasket, and that the midpoint of the suppress adjusting bead becomes the most outside. In addition, in the cylinder head gasket, a waved bead may be placed in the midsection of each suppress adjusting bead, and compression resistance of the part where the waved bead is placed is formed larger than the compression resistance of other part.

In addition, in the cylinder head gasket, only in the suppress adjusting bead placed in both ends in a longitudinal direction of the cylinder head gasket, the waved bead is placed in the midsection of the suppress adjusting bead, and the compression resistance of the part where the waved bead is placed is formed larger than the compression resistance of the other part. Accordingly, deformation of the cylinder bores at both ends in a longitudinal direction is controlled.

Also, in the cylinder head gasket, the width of the bead of the waved bead of the suppress adjusting bead is formed in a different width from the bead of the other part.

In the cylinder head gasket used for a closed-deck type engine which is not required to seal a water hole, the suppress adjusting beads and the bolt-hole beads are not connected, and a gap is provided between the suppress adjusting bead and the bolt-hole bead.

Arrangement of the bolts, a fastening force, and a cylinder structure affect the deformation of the cylinder bore. However, in the present invention, partially excessive load on the upper part of the cylinder can be eased by the structure and arrangement of the beads of the gasket so that the deformation of the cylinder bores can be controlled. Specifically, the bolt-hole bead is placed around the bolt hole where the bottom area of a fastening bolt having a great influence on the deformation of the cylinder bore is placed. Also, the adjacent bolt-hole bead is connected by the suppress adjusting bead, and the deformation of the cylinder bores is controlled by the compression resistance of the bolt-hole bead and the suppress adjusting bead.

Moreover, larger compression resistance is obtained by changing a part of the shape of the above-mentioned bead into the shape of the waved bead. At the same time, by partially changing the magnitude to the compression resistance, the suppress (compressing force) is dispersed more uniformly. Accordingly, the deformation of the cylinder bores is controlled more effectively. Specifically, the waved beads are provided partially in the outer circumferential parts of the gasket which are the large deformation parts, and the compression resistance is made stronger than the compression resistance of other bead. Also, the partial excessive load acting on the upper part of the cylinder is adjusted, and the load is more equally distributed. Accordingly, the deformation of the cylinder bores in the places where the deformation of the cylinder bores has a tendency to become large due to the excessive load is corrected.

Also, in the cylinder head gasket, at least one of the suppress adjusting beads or the bolt-hole bead is configured with a shim including compressibility instead of being formed by the bead. Materials to which synthetic resin such as silicon or fluorine is applied can be used for the shim including the compressibility, i.e., a suppress adjusting plate.

According to the cylinder head gasket of the present invention, since suppress around the cylinder bores can be equalized by placing the beads in appropriate parts, the deformation of the cylinder bores of the engine can be controlled.

### BRIEF DESCRIPTION OF THE DRAWINGS

FIG. 1 is a plan view showing a cylinder head gasket according to the first embodiment;

FIG. 2 is a plan view showing the cylinder head gasket according to the second embodiment;

FIG. 3 is a plan view showing the cylinder head gasket according to the third embodiment;

FIG. 4 is a plan view showing the cylinder head gasket according to the fourth embodiment;

FIG. 5 is a plan view showing the cylinder head gasket according to the fifth embodiment;

FIG. 6 is a plan view showing the cylinder head gasket according to the sixth embodiment;

FIG. 7 is a plan view showing the cylinder head gasket according to the seventh embodiment;

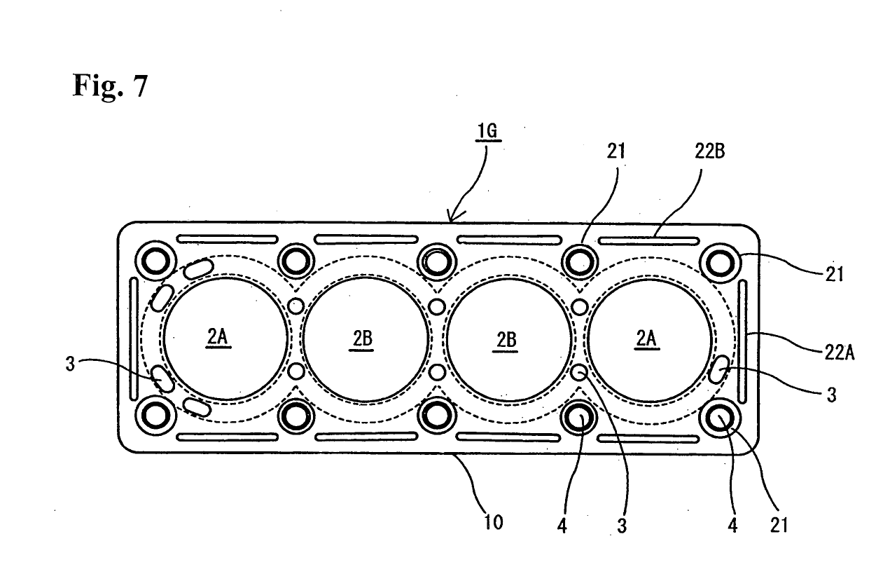

FIG. 8 is a plan view showing the cylinder head gasket according to the eighth embodiment;

FIG. 9 is a plan view showing the cylinder head gasket according to the ninth embodiment;

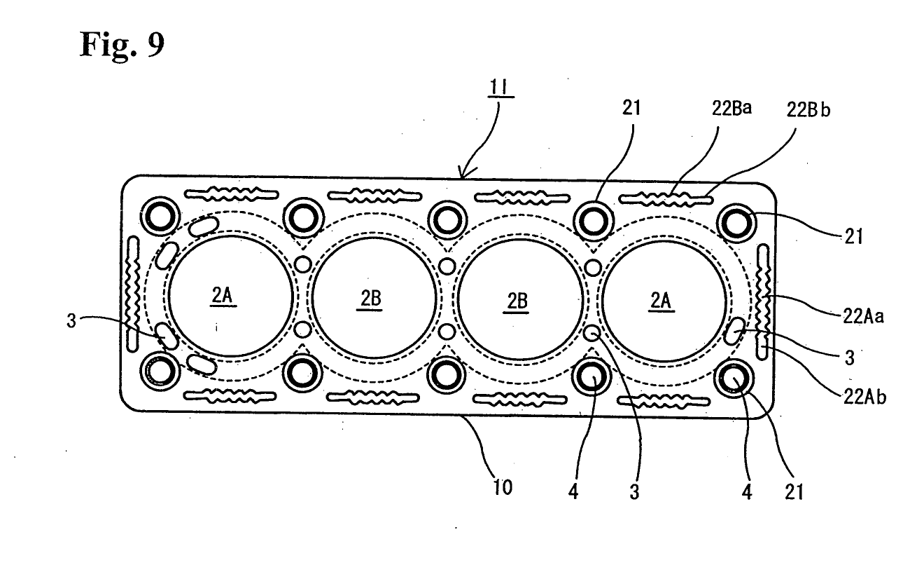

FIG. 10 is a plan view showing the cylinder head gasket according to the tenth embodiment;

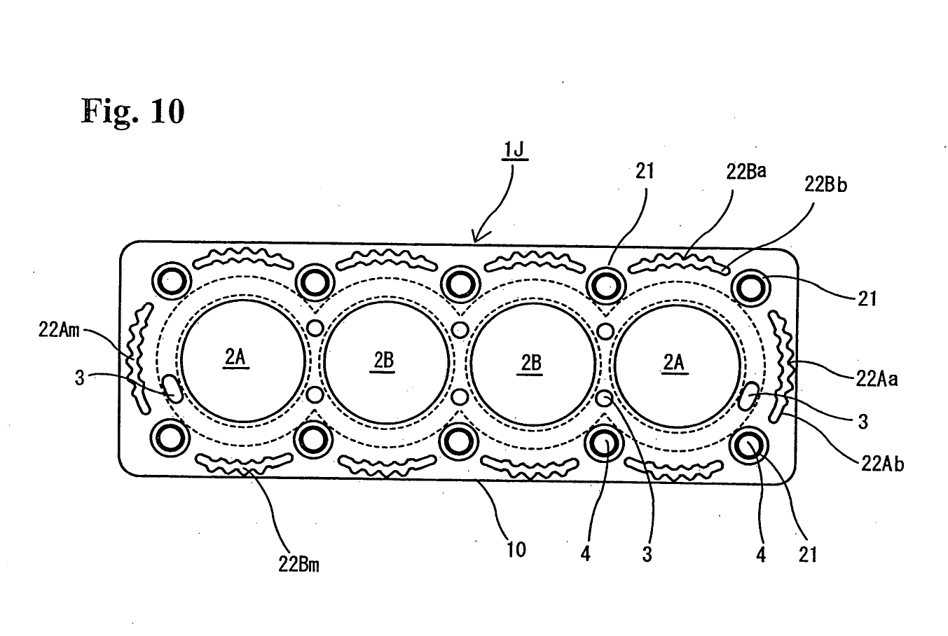

FIG. 11 is a plan view showing the cylinder head gasket according to the eleventh embodiment;

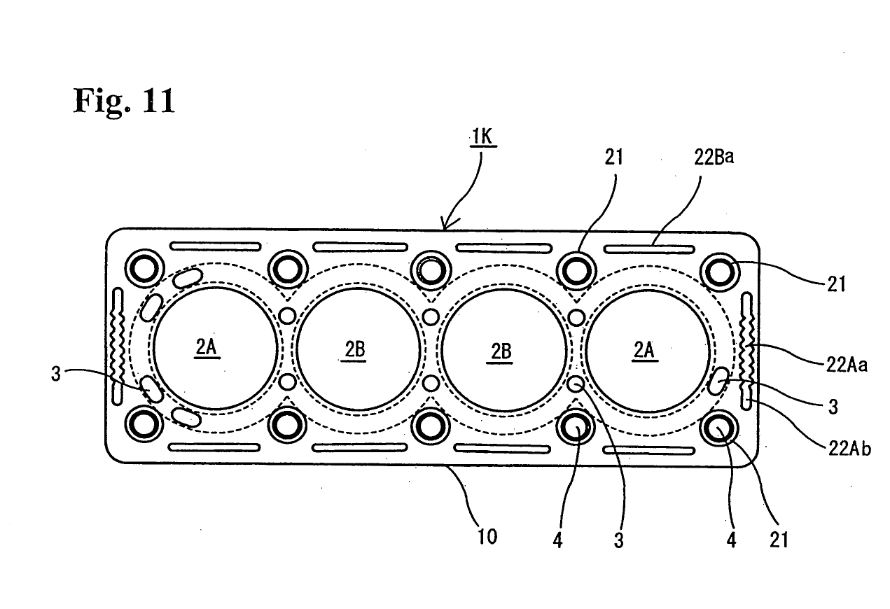

FIG. 12 is a plan view showing the cylinder head gasket according to the twelfth embodiment; and

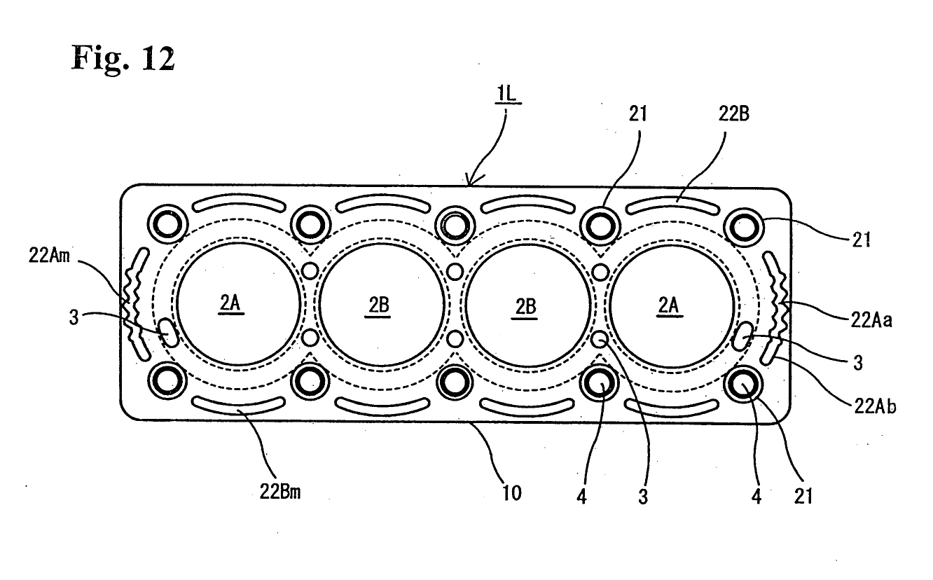

FIG. 13 is a view showing an example of a measuring result of deformation of conventional cylinder bores.

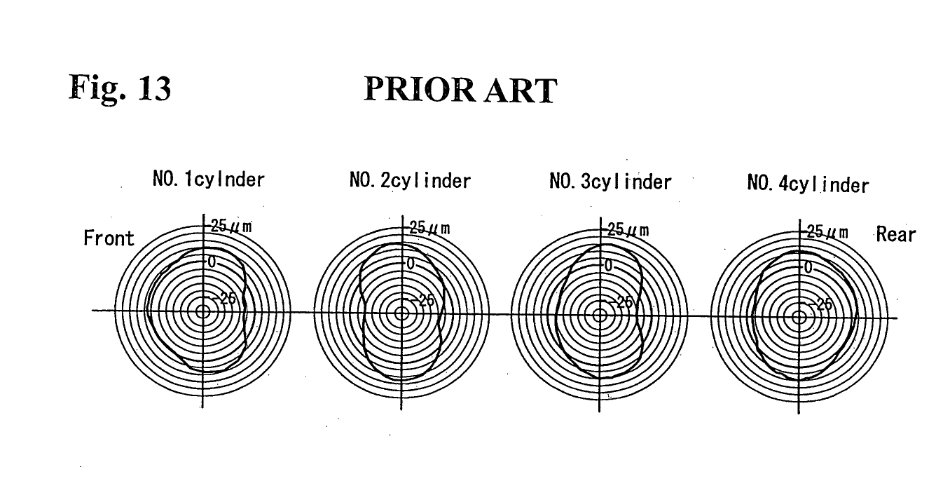

### DETAILED DESCRIPTION OF PREFERRED EMBODIMENTS

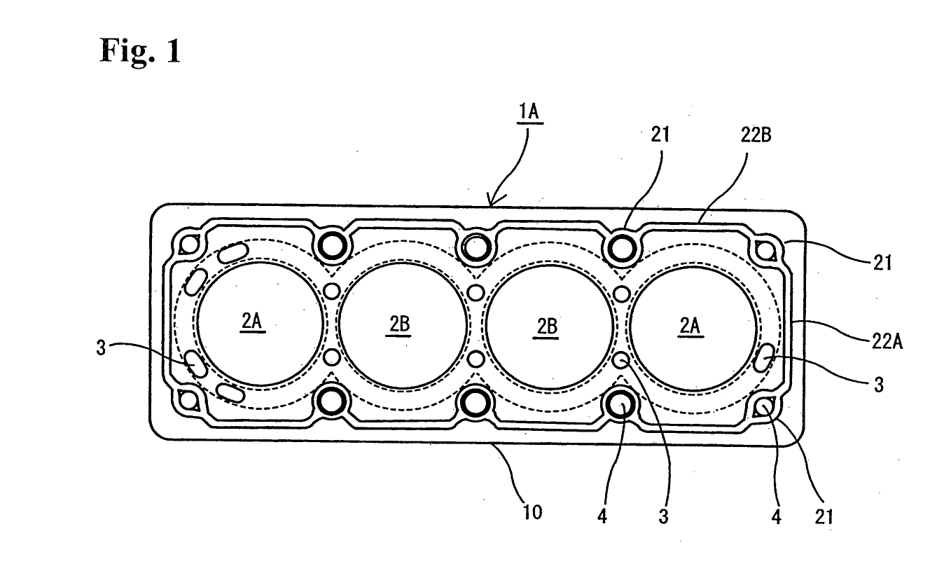

Hereinafter, embodiments of a cylinder head gasket of the present invention will be explained with reference to the drawings. In addition, FIGS. 1˜6 are type explanatory drawings, and structures are exaggeratingly shown by different sizes of cylinder bores and beads, dimensions of waved beads, and so on from actual sizes so that the structures are easily understood.

The cylinder head gasket according to the present invention is a metal gasket to be installed between engine members such as a cylinder head and a cylinder block (cylinder body) of an engine, to seal high-temperature and high-pressure combustion gas of cylinder bores, and fluid such as coolant water or oil and so on in coolant-water channels or coolant-oil channels and so on.

The cylinder head gasket is used for a multi-cylinder engine, and configured with a single or a plurality of metal plates (metal base plate) constituted by a mild steel plate, stainless annealing material (annealing material), and modified stainless material (spring steel plate). Also, the cylinder head gasket is manufactured in accordance with the shape of the engine member such as the cylinder block, and includes cylinder bores (combustion-chamber holes) 2A, 2B, liquid holes 3 for circulating coolant water or engine oil, and head-bolt holes 4 for fastening head bolts. In addition, sealing devices such as full beads not shown in the figures are provided around the cylinder bores 2A, 2B.

A cylinder head gasket 1A according to the first embodiment shown in FIG. 1 comprises a single or multiple number of metal plates. In the metal plate 10 which is one of metal plates, bolt-hole beads 21 surrounding the bolt holes 4 are provided around the base of the respective bolt holes 4, to which a great influence on the deformation of the cylinder bore is applied. At the same time, end-suppress adjusting beads 22A and side-suppress adjusting beads 22B which connect the adjacent bolt-hole beads 21 mutually are provided.

Due to the structure with the bolt-hole beads 21 and suppress adjusting beads 22A, 22B, at first, the bolt-hole beads 21 ease the large suppress generated by fastening of the fastening bolts by compressibility of the bolt-hole beads 21. Moreover, the suppress is dispersed all around a gasket 1 by the suppress adjusting beads 22A, 22B which continue to the bolt-hole beads 21. As a result, the suppress can be prevented from concentrating around the bolt holes 4. Herewith, the cylinder bores can be prevented from the deformation.

Specifically, due to the structure and arrangement of the beads of the gasket 1A, partial excessive load on the upper part of the cylinders can be eased by compression resistance of the bolt-hole beads 21 and suppress adjusting beads 22A, 22B. As a result, the deformation of the cylinder bores can be controlled.

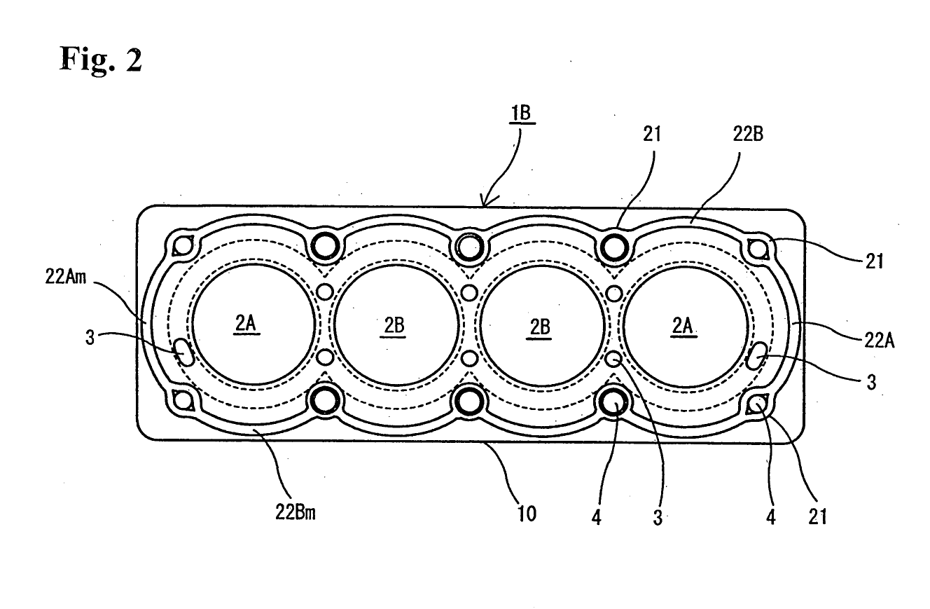

A cylinder head gasket 1B according to the second embodiment shown in FIG. 2 is formed in the same way as the cylinder head gasket 1A according to the first embodiment. However, the cylinder head gasket 1B is formed in an arc shape, wherein the suppress adjusting beads 22A, 22B project in the outer direction of the gasket 1A, and midpoints 22Am, 22Bm of the suppress adjusting beads 22A, 22B become the most outside.

Due to the structure of the second embodiment, the cylinder head gasket 1B can have the same effect on the first embodiment. Also, due to the arc-shaped suppress adjusting beads 22A, 22B, a sealing line can be formed outside a coolant-water passage 30 of an open-deck type engine so that the sealing performance of the cylinder head gasket 1B becomes excellent.

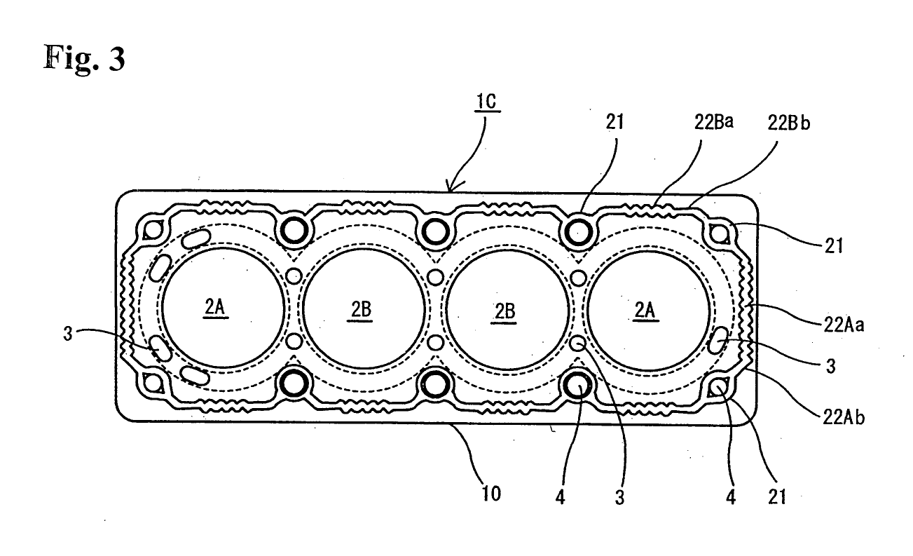

A cylinder head gasket 1C according to the third embodiment shown in FIG. 3 is formed in the same way as the cylinder head gasket 1A of the first embodiment. However, waved beads or portions 22Aa, 22Ba are placed in the midsection of each of the suppress adjusting beads 22A, 22B, and compression resistance of the parts where the waved beads 22Aa, 22Ba are placed is formed larger than the compression resistance of other parts 22Ab, 22Bb.

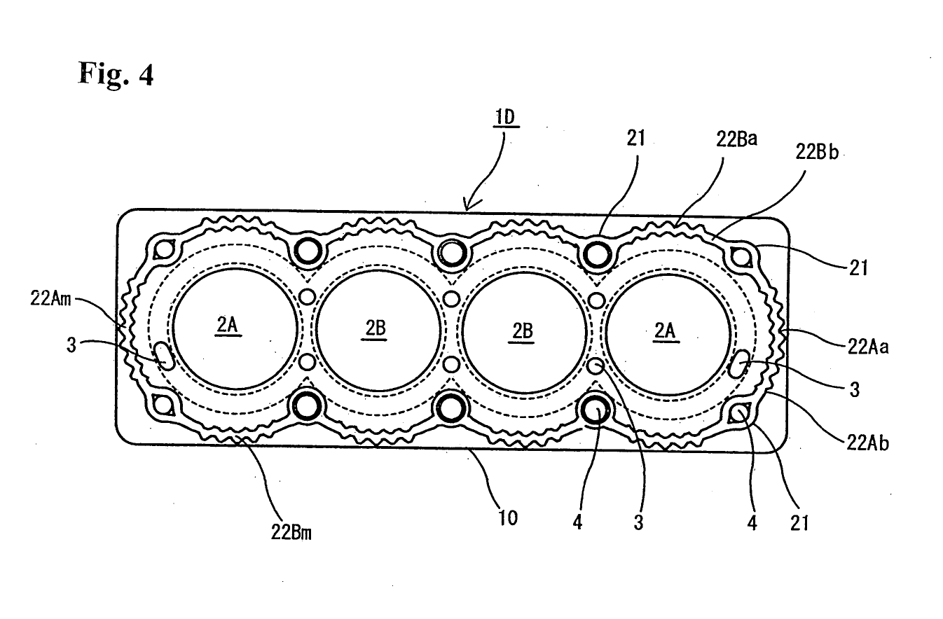

In a cylinder head gasket 1D according to the fourth embodiment shown in FIG. 4, as well as the third embodiment, in the cylinder head gasket 1B of the second embodiment, the waved beads 22Aa, 22Ba are placed in the midsection of each suppress adjusting bead 22A, 22B, and the compression resistance of the parts where the waved beads 22Aa, 22Ba are placed is formed larger than the compression resistance of the other parts 22Ab, 22Bb.

According to the cylinder head gaskets 1C, 1D of the third and fourth embodiments, the compression resistance of the midsection of each of the suppress adjusting beads 22A, 22B, i.e., the part significantly contributing to the deformation of the cylinder bore, is made particularly large. As a result, the deformation of the cylinder bore can be more effectively controlled.

Specifically, in a large deformation area of the outer circumferential part of the gaskets 1C, 1D, a shape of the parts 22Aa, 22Ba of the suppress adjusting beads 22A, 22B is partially changed into a wave (meandering) form. As a result, the parts 22Aa, 22Ba obtain larger compression resistance than the other bead parts 22Ab, 22Bb, and at the same time, provide the difference in magnitude to the compression resistance partially. Accordingly, the suppress (compressing force) is dispersed more uniformly. The load acting on the upper part of the cylinder is adjusted, and distributed uniformly. Therefore, the deformation of the cylinder bore in a part where the deformation of the cylinder bore has a tendency to become large due to excessive load can be effectively controlled.

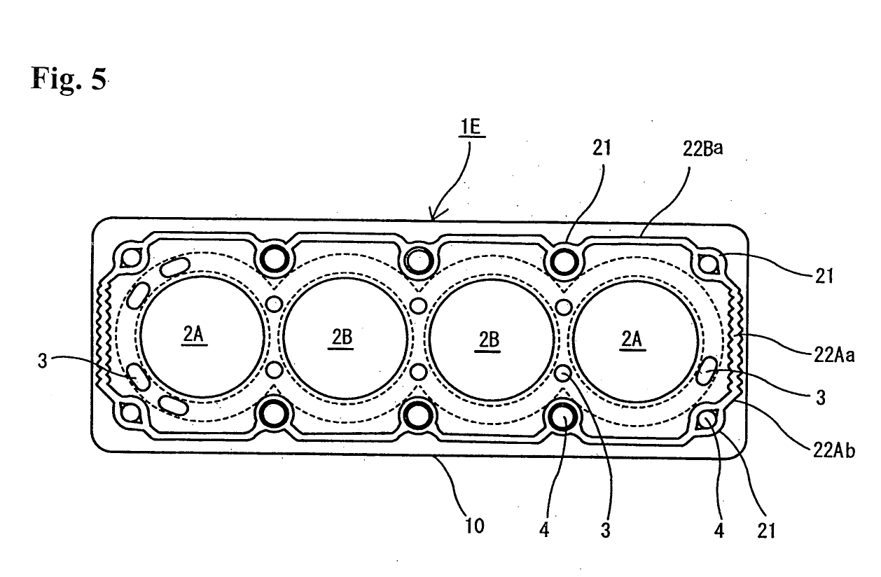

A cylinder head gasket 1E according to the fifth embodiment shown in FIG. 5 is formed in the same way as the cylinder head gasket 1A according to the first embodiment. In addition, only in the end-suppress adjusting beads 22A placed in both ends in a longitudinal direction of the cylinder head gasket 1E, the waved beads 22Aa are placed in the midsection of the end-suppress adjusting beads 22A, and the compression resistance of the parts where the waved beads 22Aa are placed is formed larger than the compression resistance of the other parts, i.e., the parts 22Ab except for the waved beads 22Aa of the end-suppress adjusting beads 22A and the suppress adjusting beads 22B except for the end-suppress adjusting beads 22A. Accordingly, the cylinder head gasket 1E is structured in such a way as to control the deformation of the cylinder bores on both ends in a longitudinal direction.

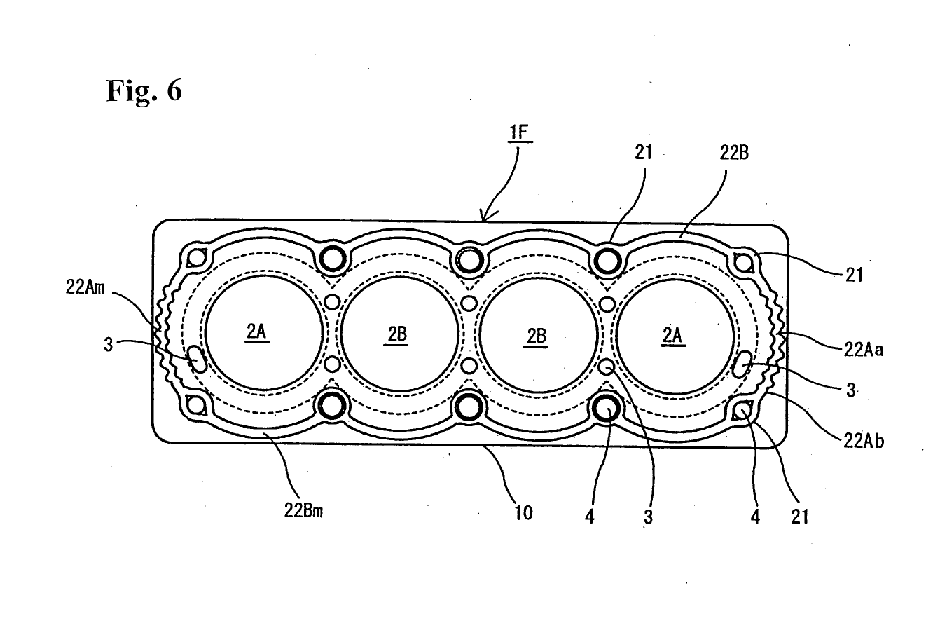

The cylinder head gasket 1F according to the sixth embodiment shown in FIG. 6 is formed in the same way as the cylinder head gasket 1B according to the second embodiment. In addition, as well as in the fifth embodiment, only in both ends of the suppress adjusting beads 22A placed in both ends in a longitudinal direction of the cylinder head gasket 1F, the waved beads 22Aa are placed in the midsection of the both ends of the suppress adjusting beads 22A, and the compression resistance of the parts where the waved beads 22Aa are placed is formed larger than the compression resistance of the other parts, i.e., the parts 22Ab except for the waved beads 22Aa of both ends of the suppress adjusting beads 22A and the suppress adjusting beads 22B except for both ends of the suppress adjusting beads 22A. Accordingly, the cylinder head gasket 1F is structured in such a way as to control the deformation of the cylinder bores on both ends in a longitudinal direction.

According to the structure of the fifth and sixth embodiments, only in both ends in a longitudinal direction, the waved beads 22Aa are placed and the compression resistance of the parts 22Aa is made larger than the compression resistance of the other parts 22Ab, 22B. As a result, especially, the deformation of the cylinder bores on both ends that tend to have a large deformation can be controlled.

Widths of the beads of the waved beads 22Aa, 22Ba of the suppress adjusting beads 22A, 22B according to the first to sixth embodiments are formed in different widths (large or small) from the beads of the other parts. As a result, the distribution of the compression resistance of the suppress adjusting beads 22A, 22B can be changed more precisely. Accordingly, measures for the deformation of the cylinder bores corresponding to the structure of an engine block can be carried out more precisely.

In addition, the cross-sectional shape of each of the bolt-hole beads 21, the suppress adjusting beads 22A, 22B, or the waved beads 22Aa, 22Ba includes an arc, sine (cosine), trapezoid, and triangle (mountain shape). The shape of the meandering (meandering shape: waveform in a plan view) of the waved beads 22Aa, 22Ba includes, for example, arc, sine (cosine), trapezoid, and triangle (mountain shape) in a plan view. The size of the meandering bead includes the length and width of the meandering of the bead. By changing the above-mentioned structures, the compression resistance of each part of the beads can be changed so that the surface pressure can be adjusted more precisely, and the deformation of the cylinder bores can be effectively controlled.

In the cylinder head gaskets 1G˜1L according to the seventh to twelfth embodiments, the suppress adjusting beads 22A, 22B and the bolt-hole beads 21 are not connected to each other, and gaps are provided between the suppress adjusting beads 22A, 22B and the bolt-hole beads 21 in the cylinder head gaskets 1A˜1F according to the first to sixth embodiments.

Namely, in the gasket 1G, the suppress adjusting beads 22A, 22B extend linearly between the bolt holes 4; in the gasket 1H, the suppress adjusting beads 22A, 22B are curved outwardly; in the gasket 1I, the suppress adjusting beads extend linearly and have waved beads 22Ba, 22Aa; in the gasket 1J, the suppress adjusting beads are curved outwardly and have waved beads 22Ba, 22Aa; in the gasket 1K, the suppress adjusting beads extend linearly, and the end-suppress adjusting beads have waved beads 22Aa; and in the gasket 1K, the suppress adjusting beads are curved outwardly, and the end-suppress adjusting beads have waved beads 11Aa, 22Am.

According to the structure, the cylinder head gasket can have a simpler structure in case of being used for a closed-deck type engine which is not required to seal a water hole.

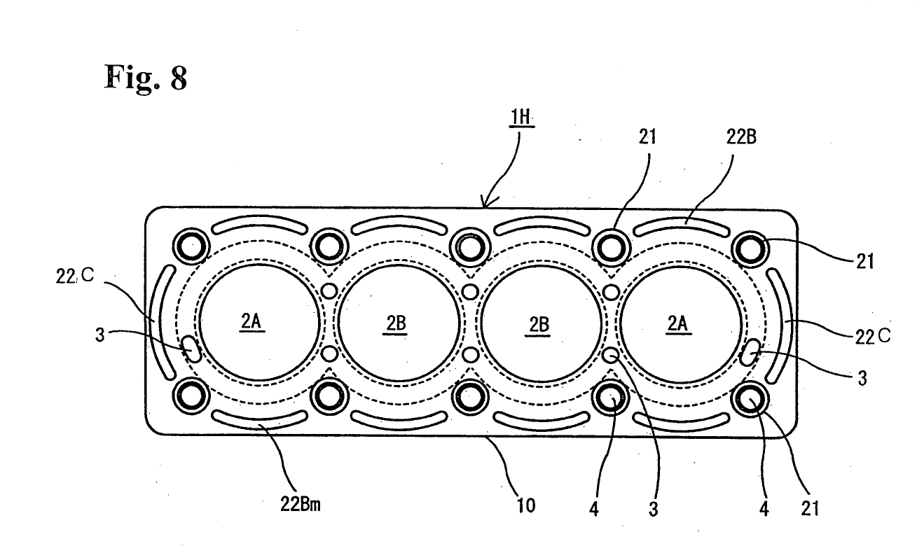

Also, in the cylinder head gasket, at least one of the suppress adjusting beads 22A, 22B or the bolt-hole beads 21 may be formed by a shim (22C in FIG. 8) with compressibility instead of being formed by the beads. Materials to which synthetic resin such as silicone or fluorine is applied can be used for the shim with the compressibility.

According to the structure, by changing the material, thickness, width, or number of coating of the shim, the compression resistance of the shim can be changed both totally and locally in the shim so that more precise suppress adjusting beads can be made and the deformation of the cylinder bore can be effectively prevented.

The disclosure of Japanese Patent Application No. 2005-017963 filed on Jan. 26, 2005 is incorporated herein.

While the invention has been explained with reference to the specific embodiments of the invention, the explanation is illustrative, and the invention is limited only by the appended claims.

What is claimed is:

1. A cylinder head gasket comprising:
a metal plate, for constituting the gasket, having at least one cylinder hole and a plurality of bolt holes arranged to surround the at least one cylinder hole,
bolt-hole beads formed in the metal plate to surround the respective bolt holes, and
suppress adjusting beads formed in the metal plate to be situated between adjacent bolt-hole beads, said suppress adjusting beads and said bolt-hole beads being spaced to have a gap therebetween.

2. A cylinder head gasket according to claim 1, wherein said metal plate includes a plurality of cylinder holes arranged linearly, longitudinal end areas outside the bolt holes, and side areas between the longitudinal end areas outside the bolt holes, said suppress adjusting beads being located in the longitudinal end areas and side areas.

3. A cylinder head gasket according to claim 2, wherein said suppress adjusting beads located in the longitudinal end areas include waved portions in middle areas thereof, said waved portion having a compression resistance greater than that in other parts.

4. A cylinder head gasket according to claim 3, wherein said suppress adjusting beads located in the side areas include waved portions in middle areas thereof.

5. A cylinder head gasket according to claim 2, wherein said suppress adjusting beads are gradually curved outwardly so that a middle point thereof projects most.

6. A cylinder head gasket according to claim 5, wherein said suppress adjusting beads located in the longitudinal end areas include waved portions in middle areas thereof, said waved portion having a compression resistance greater than that in other parts.

7. A cylinder head gasket according to claim 6, wherein said suppress adjusting beads located in the side areas include waved portions in middle areas thereof.

8. A cylinder head gasket according to claim 4, wherein said waved portion has a width different from other parts of the bead to change compressibility.

9. A cylinder head gasket according to claim 1, further comprising at least one suppress adjusting shim situated between two adjacent bolt-hole or around the bolt hole, said stress adjusting shim having a compressibility.
